(19) United States
(12) Patent Application Publication
(10) Pub. No.: US 2009/0142590 A1
(43) Pub. Date: Jun. 4, 2009

(54) COMPOSITION AND METHOD

(75) Inventors: Daniel Qi Tan, Rexford, NY (US); Darren Michael Stohr, Schenectady, NY (US); Wei Zhang, Troy, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/340,795

(22) Filed: Dec. 22, 2008

Related U.S. Application Data
(63) Continuation-in-part of application No. 12/175,799, filed on Jul. 18, 2008.
(60) Provisional application No. 60/991,871, filed on Dec. 3, 2007.

(51) Int. Cl. C04B 35/10; C04B 35/14; C04B 35/453; B32B 5/00

(52) U.S. Cl. 428/336; 501/114; 501/112; 501/117; 501/127; 501/132; 501/133

(57) ABSTRACT

A method includes contacting a transition metal oxide, a sintering additive, and a grain growth inhibitor additive to form a mixture. The transition metal oxide include particles that have an average diameter less than about 1 micrometer and sintering the mixture to a temperature profile that is sufficiently high that a sintered mass is formed from the mixture. The sintering includes at least one of a microwave sintering or a spark plasma sintering. The thermal profile is less than about 1050 degrees Celsius.

### RELATED APPLICATIONS

This application is a continuation-in-part application of U.S. patent application Ser. No. 12/175,799, filed 18 Jul. 2008, and that claims priority to provisional U.S. Pat. application Ser. No. 60/991,871, filed Dec. 3, 2007; the disclosures of which are hereby incorporated by reference.

### BACKGROUND

1. Technical Field

The invention includes embodiments that relate to a composition for use as a surge protector and/or varistor. The invention includes embodiments that relate to a method of making and/or using the composition, or derived device.

2. Discussion of Art

A varistor is an electronic component with a non-ohmic current-voltage characteristic. Varistors may protect circuits against excessive transient voltages by incorporating them into the circuit in such a way that, when triggered, they will shunt the current created by the high voltage away from the sensitive components. A varistor may be known as Voltage Dependent Resistor or VDR.

A type of varistor is the Metal Oxide Varistor (MOV). This contains a ceramic mass of zinc oxide grains, in a matrix of other metal oxides (such as small amounts of bismuth, cobalt, manganese) sandwiched between two metal plates (the electrodes). The boundary between each grain and its neighbour forms a diode junction, which allows current to flow in only one direction. The mass of randomly oriented grains is electrically equivalent to a network of back-to-back diode pairs, each pair in parallel with many other pairs. When a small or moderate voltage is applied across the electrodes, only a tiny current flows, caused by reverse leakage through the diode junctions. When a large voltage is applied, the diode junctions break down because of the avalanche effect, and a large current flows. The result of this behaviour is a highly nonlinear current-voltage characteristic, in which the MOV has a high resistance at low voltages and a low resistance at high voltages.

A varistor remains non-conductive as a shunt mode device during normal operation when voltage remains well below its “clamping voltage”. If a transient pulse (often measured in joules) is too high, the device may melt, burn, vaporize, or otherwise be damaged or destroyed. This unacceptable (catastrophic) failure occurs when “Absolute Maximum Ratings” are exceeded. Varistor degradation is defined using curves that relate current, time, and number of transient pulses. A varistor fully degrades when its “clamping voltage” has changed by 10 percent. A fully-degraded varistor may remain functional, having no catastrophic failure, and may not be visually damaged.

It may be desirable to have a method that differs from those methods currently available to provide a composition or article with properties and characteristics that differ from those properties of currently available compositions and articles.

### BRIEF DESCRIPTION

In one embodiment, a method is provided that includes contacting a transition metal oxide, a sintering additive, and a grain growth inhibitor additive to form a mixture, and sintering the mixture to a temperature profile that is sufficiently high that a sintered mass is formed from the mixture. The sintering includes at least one of a microwave sintering or a spark plasma sintering. The transition metal oxide may include particles that have an average diameter less than about 1 micrometer and the thermal profile is less than about 1050 degrees Celsius.

In one embodiment, a method includes contacting a transition metal oxide, and a sintering additive and calcining the transition metal oxide and the sintering additive together, wherein the calcining comprises heating to a temperature of about 400 degrees Celsius to provide a calcined mass. The calcined mass is contacted with a grain growth inhibitor additive to form a mixture and treating the mixture to a temperature profile that is sufficiently high that a sintered mass is formed from the mixture, and the thermal profile is less than about 1050 degrees Celsius is provided. The transition metal oxide comprises particles that have an average diameter less than about 1 micrometer. The sintering includes at least one of a microwave sintering or a spark plasma sintering.

In one embodiment, a method includes contacting a transition metal oxide, a sintering additive, and a grain growth inhibitor additive to form a mixture, and sintering the mixture to a temperature profile that is sufficiently high that a sintered mass is formed from the mixture, and the thermal profile is less than about 1050 degrees Celsius. The sintering includes at least one of a microwave sintering or a spark plasma sintering. The sintered mass can be contacted with an electrically conductive metal to form a electrical connection therebetween.

### BRIEF DESCRIPTION OF DRAWINGS

FIG. 1 shows a graph of the electric field versus the current density (current voltage graph) for a composition in accordance with one embodiment of the invention and a comparative sample.

FIG. 2 shows a graph of the electric field versus the current density (current voltage graph) for a composition in accordance with one embodiment of the invention and a comparative sample.

FIG. 3 shows SEM micrographs of a composition in accordance with an embodiment and a control blank.

### DETAILED DESCRIPTION

The invention includes embodiments that relate to a composition for use as a surge protector and/or varistor. The invention includes embodiments that relate to a method of making and/or using the composition, or the derived device.

As used herein, the term sintering is a method for making objects from particles or powders by heating the material (below its melting point) until its particles adhere to each other. Sintered refers to particles or powder that has undergone a sintering process. A sintered mass refers to the formed shape that is the result of the sintering of powders or particulate. In the sintered mass, formerly discrete particles or powder grains retain a core, and the interstitial area from one core to another core is at least partially filled with a grain boundary layer that separates the cores.

In one embodiment, a composition includes a sintered mass. The sintered mass includes a plurality of particle cores and a grain boundary layer disposed between each of the plurality of particle cores. Each of the cores may include a transition metal oxide. The grain boundary layer includes a sintering additive, a grain boundary additive, and/or a breakdown voltage additive.

In one embodiment, the particle core may include a transition metal. In one embodiment, the transition metal may be a transition metal oxide. Examples of transition metal oxides include but are not limited to zinc oxide, tin oxide, and titanium oxide. In one embodiment, the transition metal oxide includes a zinc oxide. The amount of the transition metal oxide, by weight, may be greater than about 80 percent based on the total weight of the sintered mass. In one embodiment, the amount may be in a range of from about 80 weight percent to about 85 weight percent, from about 85 weight percent to about 90 weight percent, or from about 90 weight percent to about 95 weight percent, or from about 95 weight percent to about 98 weight percent based on the total weight of the sintered mass.

In one embodiment, the grain boundary layer may be disposed between each of the plurality of the cores. The grain boundary layer includes a sintering additive. In one embodiment, the sintering additive may include one or more of aluminum, lithium, antimony, bismuth, cobalt, chromium, manganese, nickel, magnesium, or silicon. The sintering additive may include a combination of two or more of the foregoing. In one embodiment, the sintering additive includes one or more of SiO₂, Mn₂O₃, NiO, MnO₂, or MnCO₃. In one embodiment, the sintering additive may include one or more of Li₂CO₃, or LiBiO₃. In one embodiment, the sintering additive may include only one of the foregoing. The selection of the sintering additive may be based on one or more factors as the sintering additives differ in efficacy and effect. Such factors may include the desired sintering temperature, the sintering pressure, the material performance, and the desired grain characteristics.

The sintering additive may be present in an amount that is less than about 15 percent by weight, based on the total weight of the sintered mass. In one embodiment, the sintering additive amount may be in a range of from about 15 percent to about 12 percent, from about 12 percent to about 10 percent, from about 10 percent to about 8 percent, from about 8 percent to about 4 percent, from about 4 percent to about 2 percent, from about 2 percent to about 0.5 percent, from about 0.5 percent to about 0.3 percent, or from about 0.3 percent to about 0.1 percent, or from about 0.1 percent to about 0.03 percent.

In one embodiment, the grain boundary includes a grain growth inhibitor additive. In one embodiment, the grain growth inhibitor additive may include one or more of Sb₂O₃, CaO, Al₂O₃, MgO, or Fe₂O₃. In one embodiment, the grain growth inhibitor may consist essentially of only one of the foregoing. The selection of the grain growth inhibitor additive may be based on one or more factors as the grain growth inhibitor additive differ in efficacy and effect. Such factors may include the desired sintering temperature, the sintering pressure, the material performance, and the desired grain characteristics. In one embodiment, the grain growth inhibitor additive may inhibit grain growth to maintain relatively smaller grains. The grain growth inhibitor additive may control the grain size distribution, as well. In one embodiment, the grain growth inhibitor additive may be present in an amount in a range of from about 0.1 weight percent to about 0.5 weight percent, from about 0.5 weight percent to about 1.5 weight percent, or from about 1.5 weight percent to about 3 weight percent.

In one embodiment, the grain growth inhibitor additive may include a combination of two or more of the foregoing. In one embodiment, the grain growth inhibitor additive may be present in the sintered mass in an amount, by weight, that is less than about 10 percent based on the total weight of the sintered mass. In one embodiment, the grain growth inhibitor additive amount may be in a range of from about 10 weight percent to about 8 weight percent, from about 8 weight percent to about 6 weight percent, 6 weight percent to about 4 weight percent, from about 4 weight percent to about 2 weight percent, from about 2 weight percent to about 1 weight percent, from about 1 weight percent to about 0.5 weight percent, from about 0.5 weight percent to about 0.1 weight percent, or less than about 0.1 weight percent.

In one embodiment, the composition may further include a grain boundary additive. In one embodiment, the grain boundary additive includes a breakdown voltage additive. In one embodiment, the grain boundary additive may enhance the grain boundary barrier. In one embodiment, the grain boundary additive may include one or more of Co₃O₄, Co₂O₃, Cr₂O₃, Bi₂O₃, Pr₂O₃, NiO, or SnO₂. In one embodiment, the grain boundary additive consists essentially of only one of the foregoing. The selection of the grain boundary additive may be based on one or more factors as the grain boundary additive differ in efficacy and effect. Such factors may include the desired sintering temperature, the sintering pressure, the material performance, and the desired grain characteristics. The grain boundary additive may be present in an amount less than about 1 weight percent. In one embodiment, the grain boundary additive may be present in an amount in a range of from about 0.01 weight percent to about 0.5 weight percent, from about 0.5 weight percent to about 0.75 weight percent, or from about 0.75 weight percent to about 1 weight percent. In one embodiment, the composition is free of Co₂O₃. In another embodiment, the amount of Co₂O₃ is less than about 0.05 weight percent.

In one embodiment, the additive may include a combination of two or more of the foregoing. In one embodiment, the grain boundary additive may be present in the sintered mass in an amount, by weight, that is less than about 10 percent based on the total weight of the sintered mass. In one embodiment, the grain boundary additive is present in an amount in a range of from about 10 weight percent to about 8 weight percent, from about 8 weight percent to about 6 weight percent, from about 6 weight percent to about 4 weight percent, from about 4 weight percent to about 2 weight percent, from about 2 weight percent to about 1 weight percent, from about 1 weight percent to about 0.5 weight percent, from about 0.5 weight percent to about 0.1 weight percent, or less than about 0.1 weight percent.

In one embodiment, the average distance from one core to an adjacent core in the plurality of cores is less than about 1 micrometer. In one embodiment, the average distance may be in a range of from about 1 micrometer to about 0.8 micrometers, or from about 0.8 micrometers to about 0.5 micrometers. In another embodiment, the average distance may be in a range of from about 500 nanometers to about 400 nanometers, from about 400 nanometers to about 300 nanometers, from about 300 nanometers to about 250 nanometers, from about 250 nanometers to about 200 nanometers, from about 200 nanometers to about 150 nanometers, from about 150 nanometers to about 100 nanometers, from about 100 nanometers to about 50 nanometers, or less than about 50 nanometers.

In one embodiment, the average diameter of the core in the plurality of cores is less than about 1 micrometer. In one embodiment, the average diameter may be in a range of from about 1 micrometer to about 0.8 micrometers, or from about 0.8 micrometers to about 0.5 micrometers. In another embodiment, the average diameter may be in a range of from about 500 nanometers to about 400 nanometers, from about 400 nanometers to about 300 nanometers, from about 300 nanometers to about 250 nanometers, from about 250 nanometers to about 200 nanometers, from about 200 nanometers to about 150 nanometers, from about 150 nanometers to about 100 nanometers, from about 100 nanometers to about 50 nanometers, or less than about 50 nanometers.

The micro-structure or nano-structure of the composition may be expressed in terms of an average distance from one core to an adjacent core in the sintered mass. The average distance from one core to an adjacent core in the sintered mass may be less than 5 micrometers. In one embodiment, the average distance may be in a range of from about 1 micrometer to about 0.8 micrometers, or from about 0.8 micrometers to about 0.5 micrometers. In another embodiment, the average distance may be in a range of from about 500 nanometers to about 400 nanometers, from about 400 nanometers to about 300 nanometers, from about 300 nanometers to about 250 nanometers, from about 250 nanometers to about 200 nanometers, from about 200 nanometers to about 150 nanometers, from about 150 nanometers to about 100 nanometers, from about 100 nanometers to about 50 nanometers, or less than about 50 nanometers. An exemplary core-to-core average distance may be in a range of from about 35 nanometers to about 75 nanometers.

The distance of one core to another core, coupled with the core size, may affect the average thickness of the grain boundary layer. In one embodiment, the average thickness of the grain boundary layer may be less than about 1 micrometer. In another embodiment, the average thickness may be in a range of from about 1 micrometer to about 0.8 micrometers, or from about 0.8 micrometers to about 0.5 micrometers. In yet another embodiment, the average thickness may be in a range of from about 500 nanometers to about 400 nanometers, from about 400 nanometers to about 300 nanometers, from about 300 nanometers to about 250 nanometers, from about 250 nanometers to about 100 nanometers, from about 100 nanometers to about 50 nanometers, from about 50 nanometers to about 35 nanometers, from about 35 nanometers to about 20 nanometers, or less than about 20 nanometers.

The grain boundary layer thickness, may be expressed as a mean value in nanometers. The mean value for the grain boundary layer may be less than about 50 nanometers. In one embodiment, the mean value may be in a range of from about 50 nanometers to about 10 nanometers, from about 10 nanometers to about 1 nanometer, or from about 1 nanometer to about 0.1 nanometers.

In addition to such factors as the uniformity of core diameters, the uniformity of distribution of materials, and the uniformity of the grain boundary layer, the average distance of the cores from one to another may affect the performance, properties and characteristics of the varistor device made therefrom. Particularly, the diode junction performance, and the number of diode junctions per unit volume, may flow directly from the core spacing parameter.

In one embodiment, the sintered mass may have a dielectric strength or breakdown field of greater than about 0.5 kV/mm. In one embodiment, the dielectric strength or breakdown field is in a range of from about 0.5 kV/mm to about 1 kV/mm, from about 1 kV/mm to about 1.5 kV/mm, from about 1.5 kV/mm to about 2 kV/mm, from about 2 kV/mm to about 2.5 kV/mm, from about 2.5 kV/mm to about 2.8 kV/mm, or greater than about 2.8 kV/mm. In one embodiment, the sintered mass may have a non-linearity coefficient (α) of greater than 25. In one embodiment, the non-linearity coefficient (α) may be in a range of from about 25 to about 50, from about 50 to about 75, from about 75 to about 100, from about 100 to about 125, from about 125 to about 140, or greater than about 140.

The thermal profile may play a role in the melt temperature of the electrode of the MOV device. If the thermal profile is higher than the electrode melt temperature, then the electrode may be melted, damaged or destroyed. A higher thermal excursion during manufacture or sinter may then require an electrode with a corresponding melt temperature suitable for use after exposure to that temperature. Lower temperature capable electrode materials may be economically desirable, if the other performance parameters are correct. In addition, if the thermal profile shows a temperature excursion too high, the micro-structure or nano-structure may change and the sintered particles may melt and flow together rather than remain as a sintered mass. This may need to be balanced, as at least some heat is needed to get the particles to sinter in the first instance.

In one embodiment, a sintered mass may be produced by mixing a transition metal oxide, a sintering additive, and a grain boundary additive under defined conditions to form a mixture. The mixture can be treated to a determined temperature profile. In one embodiment, the temperature profile includes exposure to a sinter temperature of less than about 1050 degrees Celsius. The composition may have a thermal profile also known as thermal history that may include exposure to a sintering temperature of not greater than about 1050 degrees Celsius. In one embodiment, the thermal profile includes exposure to a sinter temperature in a range of from about 1050 degrees Celsius to about 1000 degrees Celsius, from about 1000 degrees Celsius to about 950 degrees Celsius, from about 950 degrees Celsius to about 900 degrees Celsius, from about 900 degrees Celsius to about 850 degrees Celsius, or from about 850 degrees Celsius to about 800 degrees Celsius, or from about 800 degrees Celsius to about 750 degrees Celsius, or from about 750 degrees Celsius to about 600 degrees Celsius, or from about 600 degrees Celsius to about 450 degrees Celsius.

In one embodiment, the sintering includes at least one of microwave sintering or spark plasma sintering. In one embodiment, the sintering process is a spark plasma sintering. In another embodiment, the spark plasma sintering may be carried out by passing a pulsewise DC electric current through the mixture or through a compacted form of the mixture, while pressure may be applied. In another embodiment, spark plasma sintering may be carried out so that the temperature of the mixture may rise to a sintering temperature at a rate that may have influence on the properties of the final product at temperature. In one embodiment, the heating rate may be at a rate of at least about 75 degrees Celsius per minute. In another embodiment, the heating rate may be at a may be in a range from about 75 degrees Celsius per minute to about 350 degrees Celsius per minute. In one embodiment, the heating rate may be at a rate of at least about 350 degrees Celsius per minute. In another embodiment, the heating rate may be in a range of from about 350 degrees Celsius per minute to about 450degrees Celsius per minute, from about 450 degrees Celsius per minute to about 550 degrees Celsius per minute, from about 550 degrees Celsius per minute to about 600 degrees Celsius per minute, from about 600 degrees Celsius per minute to about 700 degrees Celsius per minute, from about 700 degrees Celsius per minute to about 850 degrees Celsius per minute, or from about 850 degrees Celsius per minute to about 1000 degrees Celsius per minute.

In one embodiment, the heating may be continued to the sintering temperature, and the sintered mass may be held at the sintering temperature for a period of time. In one embodiment, the length of time during which the sintered mass is held at the sintering temperature may be in a range of from about 1 minute to about 3 minutes, or from about 3 minutes to about 6 minutes, from about 6 minutes to about 10 minutes, from about 10 minute to about 15 minutes, or from about 15 minutes to about 30 minutes.

In one embodiment, once the sintering temperature is reached, the sintering temperature itself and the length of time that the sintering temperature may be maintained may be varied to minimize the grain growth. The heating rate and the sintering temperature may be controlled by adjustment of the parameters of the electric current applied to the mixture. The optimum level of each system parameter may be readily determinable by routine testing and adjustment. In one embodiment, the current may be a pulsed DC current of at least about 100 Ampere per centimeter square (A/cm²). In another embodiment, the current may be a pulsed DC current may be in a range from about 100 Ampere per centimeter square (A/cm²) to about 250 Ampere per centimeter square (A/cm²). In one embodiment, the current may be a pulsed DC current of at least about 250 Ampere per centimeter square (A/cm²). In another embodiment, the current may be a pulsed DC current in a range of from about 250 Ampere per centimeter square to about 400 Ampere per centimeter square, from about 400 Ampere per centimeter square to about 550 Ampere per centimeter square, from about 550 Ampere per centimeter square to about 700 Ampere per centimeter square, from about 750 Ampere per centimeter square to about 1000 Ampere per centimeter square, from about 1000 Ampere per centimeter square to about 2500 Ampere per centimeter square, from about 2500 Ampere per centimeter square to about 4000 Ampere per centimeter square, from about 4000 Ampere per centimeter square to about 7500 Ampere per centimeter square, or from about 7500 Ampere per centimeter square to about 10000 Ampere per centimeter square. In another embodiment, the spark plasma sintering may be carried out at a pressure of greater than at least about 10 mega Pascals (MPa). In another embodiment, the spark plasma sintering may be carried out at a pressure in a range of from about 10 mega Pascals to about 25 mega Pascals, from about 25 mega Pascals to about 40 mega Pascals, from about 40 mega Pascals to about 75 mega Pascals, or from about 75 mega Pascals to about 100 mega Pascals. In one embodiment, the pressure may be applied by uniaxial compression under vacuum of at least less than about 10 Torr.

In one embodiment, the spark plasma sintering process may reduce the processing time as compared to the conventional heating process and may thereby minimize the total energy expenditure required to process identical lots of material. The mechanical properties of sintered mass processed by this method have also been shown to be superior to those prepared by conventional means.

In one embodiment, the sintering process may include microwave sintering. In one embodiment, the microwave sintering may be a direct microwave sintering. The microwave sintering process may be carried out at a temperature of at least about 400 degrees Celsius. In one embodiment, the microwave sintering may be carried out at a temperature in a range of from about 400 degrees Celsius to about 450degrees Celsius, from about 450 degrees Celsius to about 550 degrees Celsius, from about 550 degrees Celsius to about 600 degrees Celsius, from about 600 degrees Celsius to about 700 degrees Celsius, from about 700 degrees Celsius to about 850 degrees Celsius, from about 850 degrees Celsius to about 1050 degrees Celsius, or from about 1050 degrees Celsius to about 1500 degrees Celsius. In another embodiment, the microwave sintering may be carried out at a heating rate of at least about 350 degrees Celsius per minute. In another embodiment, the heating rate may be in a range of from about 350 degrees Celsius per minute to about 450 degrees Celsius per minute, from about 450 degrees Celsius per minute to about 550 degrees Celsius per minute, from about 550 degrees Celsius per minute to about 600 degrees Celsius per minute, from about 600 degrees Celsius per minute to about 700 degrees Celsius per minute, from about 700 degrees Celsius per minute to about 850 degrees Celsius per minute, or from about 850 degrees Celsius per minute to about 1000 degrees Celsius per minute.

In one embodiment, the microwave sintering time may be at least about 1 minute. In another embodiment, the microwave sintering time may be in a range of from about 1 minute to about 3 minutes, or from about 3 minutes to about 6 minutes, from about 6 minutes to about 10 minutes, from about 10 minute to about 15 minutes, or from about 15 minutes to about 30 minutes.

In one embodiment, microwave sintering process may give a sintered mass that may have a uniform distribution of fine nano-size grains as compared to conventional sintering process. In one embodiment, microwave sintering may give a sintered mass without significant grain growth, which may be needed for the preservation of nano-structures, especially at the grain boundary region. Microwave sintering may also result in increased densification of the nano-composites compared to the densities achieved using conventional sintering under comparable sintering conditions. In another embodiment, microwave sintering may lead to reduction of the sintering time and processing time thereby improving the cost efficiency.

In one embodiment, direct microwave sintering may be achieved in the mixture as a consequence of the dielectric constant and the dielectric loss of the material at a specific microwave frequency. The specific frequency, that is the optimal frequency at which a given material may effectively couple directly with microwave energy, may be given by the complex permittivity of the material. That is to say, if the dielectric constant and the dielectric loss factor are such that when irradiated at a specific microwave frequency, the material will absorb, store, the microwave energy and the microwave energy transform into thermal energy known as susceptibility of the mixture. In one embodiment, the mixture may have a susceptibility of at least about room temperature. In another embodiment, the mixture may have a susceptibility of at least about 2.25 gigaHertz at room temperature.

In one embodiment, the method includes calcining the transition metal oxide and the sintering additive together before forming the mixture. Calcining of the transition metal oxide and the sintering additive includes heating to a temperature that is greater than about 400 degrees Celsius. In one embodiment, calcining includes exposure of the mixture to a temperature in a range of from about 400 degrees Celsius to about 450 degrees Celsius, from about 450 degrees Celsius to about 550 degrees Celsius, from about 550 degrees Celsius to about 600 degrees Celsius, from about 600 degrees Celsius to about 650 degrees Celsius, or from about 650 degrees Celsius to about 800 degrees Celsius.

In one embodiment, a method includes contacting a transition metal oxide with a sintering additive to form a premix, wherein the transition metal oxide comprises particles that have an average diameter less than about 1 micrometer. The premix may be calcined. The clacining includes heating to a temperature of about 450 degrees Celsius to provide a calcined mass. The calcined mass may be contacted with a grain growth inhibitor additive to form a mixture. The mixture is sintered at a temperature profile that is sufficiently high that a sintered mass is formed from the mixture, and the thermal profile is less than about 1050 degrees Celsius.

In one embodiment, the method includes contacting the sintered mass with an electrically conductive material to form an electrical connection therebetween. The electrically conductive material electrode may be formed by pressing, heating, melt flowing, casting, printing, metallizing/etching, and the like. Mechanical methods of attachment may be available in some embodiments. Alternatively, a precursor material may be disposed on the sintered mass and converted into an electrically conductive material. In one embodiment, the electrically conductive materials may include one or more of platinum, palladium, copper, silver, tin, aluminum, iron, carbon, nickel, antimony, chromium, or gold. Alloys of the foregoing are also suitable based on application specific parameters (such as brass or Ni—Sn). In one embodiment, the electrically conductive material consists essentially of silver. In one embodiment, the electrically conductive material includes carbon, and the carbon is amorphous or structured (such as in a nanotube or nanowire).

In one embodiment, the composition includes a sintered reaction product of transition metal oxide particles that have an average diameter that is less than about 1 micrometer; and sintering additive particles having an average diameter that is less than about 1 micrometer. The grain growth inhibitor additive particles may have an average diameter that is less than about 1 micrometer. Due to the change in available surface area, and packing tendencies, particles of different sizes may form sintered masses having differing properties and characteristics.

In one embodiment, the composition includes a sintered mass of particles that may include a transition metal oxide, a sintering additive, and a grain growth inhibitor additive. The sintered mass may have a density that is greater than 98 percent of theoretical density for a composition comprising the transition metal oxide.

In one embodiment, the composition includes sintered particles that include a transition metal oxide, a sintering additive, and a grain growth inhibitor additive and defining grains. The grains may have grain boundaries that define the grains to have an average grain size of less than about 0.8 micrometers. In one embodiment, the method includes contacting a transition metal oxide, a sintering additive, and a grain growth inhibitor additive to form a mixture. The mixture may be treated to a temperature profile. In one embodiment, the temperature profile includes exposure to a sinter temperature of less than about 1050 degrees Celsius.

### EXAMPLES

The following examples illustrate methods and embodiments in accordance with the invention, and as such do not limit the claims. Unless specified otherwise, all ingredients may be commercially available from such common chemical suppliers as Alpha Aesar, Inc. (Ward Hill, Mass.), Sigma Aldrich (St. Louis, Mo.), Horsehead Corporation (Monaca, Pa.), Nanostructured and Amorphous Materials, Inc. (Houston, Tex.), and the like.

The various components and the weight percent for each of the components for examples 1 to 3 are given in Table 1.

TABLE 1

| Composition | | | | Comparative |
|---|---|---|---|---|
| (Weight percent) | Sample 1 | Sample 2 | Sample 3 | Sample 1 |
| ZnO | 94 | 85.5 | 94.69 | 92.21 |
| Bi₂O₃ | 0.5 | 2 | 3 | 1.40 |
| Sb₂O₃ | 1 | 3 | 1.5 | 3.75 |
| Al₂O₃ | — | 2 | 0.01 | — |
| SiO₂ | 2 | 3 | — | 0.07 |
| Cr₂O₃ | 0.5 | — | — | 1.02 |
| MnO | — | — | — | 0.4 |
| Mn₂O₃ | 0.5 | — | 0.1 | — |
| MgO | — | 2 | — | — |
| Fe₂O₃ | — | — | — | 0.04 |
| Co₂O₃ | — | — | — | 1.17 |
| Co₃O₄ | 0.5 | 2.5 | 0.5 | — |
| NiO | 1 | — | 0.2 | — |
| SnO₂ | — | — | — | 0.93 |

### Example 1

A mixture is formed from zinc oxide, and additives selected from cobalt, antimony, nickel, and chromium oxide nanopowders with bismuth, silicon, manganese oxide nanopowders in a ratio given in Table 1. The zinc oxide is commercially obtainable from Horsehead Coporation, (Monaca, Pa.). The additives are commercially obtainable from Nanostructured and Amorphous Materials Inc. (Houston, Tex.).

The materials form a mixture in a mixed oxide wet process. The mixture is milled in a ball mill for about 6 hours in a ratio materials:ball:isopropyl alcohol=1:5:2 to form a slurry. The slurry is dried at 100 degrees Celsius. The dried powder is sieved and calcined at 550 degrees Celsius for about 2 hours in a Thermolyne 1400 furnace. The calcined powder is then ball milled for about 4 hours. The slurry formed is dried at 100 degrees Celsius and the dried powder is sieved. The powder is then pressed into pellets (thickness of about 1.5 millimeters) with a force of about 10000 pounds for about 1 minute. The pellet is sintered using microwave sintering process in a microwave sintering furnace. The sintering temperature is set in at about 750 degrees Celsius to about 1000 degrees Celsius. The microwave energy source is switched on and the internal heating rate is maintained at about 900 degrees Celsius per minute. The sintering is carried out for a duration of 10 minutes. Electromagnetic wave penetrating in the pellets enhances the reaction and sintering mechanism inside the pellets. The resultant product is Sample 1, which has the compositional distribution as indicated in Table 1.

### Example 2

A mixture is formed from zinc oxide, and additives selected from oxide nanopowders cobalt, and antimony, with nanopowder oxides of bismuth, silicon, aluminum and magnesium in a ratio given in Table 1.

The materials are mixed using a mixed Oxide Wet Process. The mixture is milled in a ball mill for about 6 hours in a ratio materials:ball:isopropyl alcohol=1:5:2 to form a slurry. The slurry is dried at 100 degrees Celsius. The dried powder is sieved and calcined at 550 degrees Celsius for about 2 hours in a Thermolyne 1400 furnace. The calcined powder is then ball milled for about 4 hours. The slurry formed is dried at 100 degrees Celsius and the dried powder is sieved. The powder is then pressed into pellets (thickness of about 1.5 millimeters) with a force of about 10000 pounds for about 1 minute. The pellet is sintered using microwave sintering process in a microwave sintering furnace. The sintering temperature is set in at about 750 degrees Celsius to about 100 degrees Celsius. The microwave energy source is switched on and the internal heating rate is maintained at about 900 degrees Celsius per minute. The sintering is carried out for a duration of 10 minutes. Electromagnetic wave penetrating in the pellets enhances the reaction and sintering mechanism inside the pellets. The resultant product is Sample 2, which has the compositional distribution indicated in Table 1.

### Example 3

A mixture is formed from zinc oxide (from Horsehead Coporation, Monaca, Pa.), and additives selected from powders of cobalt, nickel, and antimony-based materials (from Nanostructured and Amorphous Materials Inc, Houston, Tex.), and with powders of bismuth, aluminum and manganese-based materials in amounts as given in Table 1.

The materials are mixed using a mixed oxide wet process. The mixture is milled in a ball mill for about 6 hours in a ratio of powder materials:ball:isopropyl alcohol=1:5:2 to form a slurry. The slurry is dried at 100 degrees Celsius. The dried powder is sieved and calcined at 550 degrees Celsius for about 2 hours in a Thermolyne 1400 furnace. The calcined powder is then ball milled for about 4 hours. The slurry formed is dried at 100 degrees Celsius and the dried powder is sieved. The powder is then pressed into pellets (thickness of about 1.5 millimeters) with a force of about 10000 pounds for about 1 minute. The pellet is sintered using microwave sintering process in a microwave sintering furnace. The sintering temperature is set in at about 750 degrees Celsius to about 100 degrees Celsius. The microwave energy source is switched on and the internal heating rate is maintained at about 900 degrees Celsius per minute. The sintering is carried out for a duration of 10 minutes. Electromagnetic wave penetrating in the pellets enhances the reaction and sintering mechanism inside the pellets. The resultant product is Sample 3, which has the compositional distribution indicated in Table 1.

Comparative sample 1 is prepared using the conventional sintering process with the composition as described for comparative sample 1 in Table 1. The materials are mixed using a mixed Oxide Wet Process. The mixture is milled in a ball mill for about 6 hours in a ratio materials:ball:isopropyl alcohol=1:5:2 to form a slurry. The slurry is dried at 100 degrees Celsius. The dried powder is sieved and calcined at 550 degrees Celsius for about 2 hours in a Thermolyne 1400 furnace. The calcined powder is then ball milled for about 4 hours. The slurry formed is dried at 100 degrees Celsius and the dried powder is sieved. The powder is then pressed into pellets (thickness of about 1.5 millimeters) with a force of about 10000 pounds for about 1 minute. The pellet is sintered in a Uniaxial Press at different temperatures for about 2 hours at about 950 degrees Celsius, about 1050 degrees Celsius at a rate of about 5 degrees Celsius per minute. The resultant product is Comparative Sample 1, which has the compositional distribution indicated in Table 1.

### Current—Voltage (I-V) Measurement:

A 10 kiloOhm or 100 MegaOhm resistor is connected in parallel to the varistor and a voltage is applied. V1, the total voltage on sample and varistor is measured using a high voltage probe. V2, the voltage on the resistor is measured by a multimeter. V2 is used to calculate the current flowing through the varistor. V1-V2 is the voltage on the Samples 1-6. To measure I-V curve, at low voltage, a 100 MOhm resistor is used until the voltage on it is higher than about 100 Volts. A 10 kilo Ohm resistor is used to measure the I-V curve under high voltage (higher than about 100 Volts).

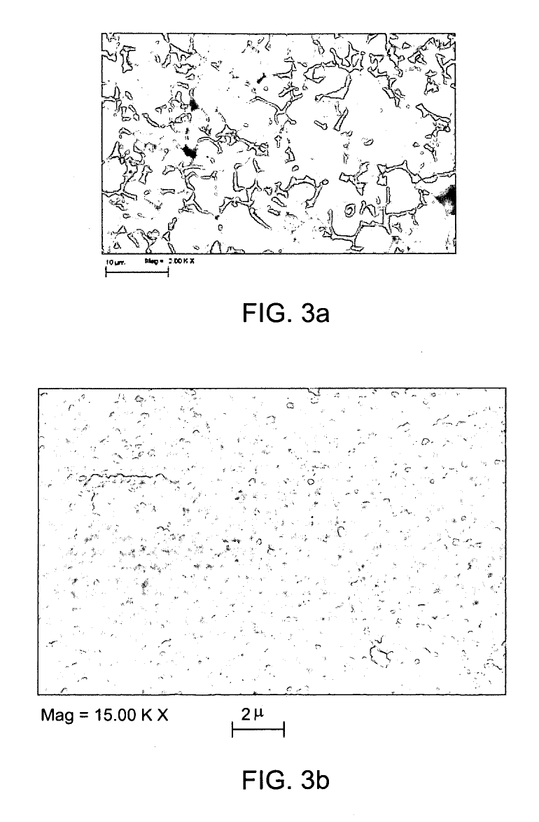

FIG. 3 shows the results of metal oxide varistor materials of Samples 1 relative to the comparative sample 1. The materials of Sample 1 display relatively better breakdown strength and relatively better nonlinearity compared to Comparative Sample 1. The breakdown fields (electric fields when current density is 1 milliAmp per square centimeter) and nonlinearity coefficient α calculated are summarized in Table 2.

TABLE 2
Breakdown fields and nonlinearity of metal oxide varistor materials of
Samples 1-3 and commercially available metal oxide varistor material

| | Sintering | Breakdown | |
|---|---|---|---|
| | Temperature (° C.)/ | Field | Nonlinearity |
| Composition | Time (Hours) | (V/mm) | coefficient α |
| Sample 1 | 1000/2 | 1343 | 63 |
| | 1050/2 | 972 | 138 |
| Sample 2 | 950/2 | 2800 | 40 |
| | 1000/2 | 2216 | 18 |
| Sample 3 | 850/2 | 1710 | 77 |
| | 900/2 | 546 | 19 |
| | 950/2 | 515 | 77 |
| | 1000/2 | 400 | 42 |
| | 1050/2 | 315 | 79 |
| Comparative | NA | 125 | 22 |
| Sample 1 | | | |

Table 2 shows that the metal oxide varistor materials of Samples 1-3 perform better than the comparative sample 1. For example, Sample 3 gives a breakdown field of greater than about 1700 volts per millimeter and a nonlinearity coefficient (α) of about 77.

### Example 4

A mixture is formed from zinc oxide, and additives selected from oxide powders cobalt, and antimony, with powder oxides of bismuth, silicon, aluminum and chromium in amounts as given in Table 3. Unless otherwise indicated, the powders are nanoscale and have a narrow size distribution.

The materials are mixed and the mixture is milled in a ball mill for about 6 hours. The slurry is dried at 100 degrees Celsius. The dried powder is sieved and calcined at 550 degrees Celsius for about 2 hours in a THERMOLYNE 1400 furnace. The calcined powder is then ball milled for about 4 hours. The slurry formed is dried at 100 degrees Celsius and the dried powder is sieved and weighed out in a plastic weigh boat. Two disks of graphite foil are punched out of a 0.5 mm thick sheet. The diameter of the graphite foil disks is 15.25 mm, slightly smaller than the ID of the graphite die. The graphite die used is 30 mm tall, with a 30 mm outer diameter (OD) and a 15.35 mm inner diameter. The graphite punches are 20 mm long. The bottom punch is inserted in the die. One of the graphite disks is placed in the die over the bottom punch. The weighed mixture is then added to the graphite die. The top punch is inserted into the die to partially consolidate the mixture and is then removed. The second graphite disk is then placed on top of the mixture. The top punch is again inserted into the die. The mixture and punches are centered in the die.

The graphite spacers are placed on the bottom electrode of the Spark Plasma Sintering (SPS) unit and centered below the top electrode. The graphite die containing the sample mixture is then centered on the graphite spacers. A second set of graphite spacers are then centered on the top punch. The bottom electrode is raised until the top set of graphite spacers are in firm contact with the top electrode. The control is inserted into a 1.5 mm deep hole in the center of the side of the die. The surfaces of the top and bottom outer wall of the SPS are cleaned with methanol to remove any powder or dust that might inhibit the vacuum seal of the SPS chamber. The SPS chamber is closed and the gas valves into the chamber are closed. A vacuum is applied to the SPS chamber. A clamping force of about 3.1 kN is applied to the spacers and the die/punch set. The displacement of the ram is zeroed. The pressure on the punch and die is increased to 40 MPa. The system is ready to operate when the chamber has a pressure less than 20 Pa.

The sample is heated to about 575 degrees Celsius at a heating rate of about 96 degrees Celsius per minute. The pressure is increased to 60 MPa when the sample has reached its sintering temperature. The sample is held at temperature as per the powder's firing schedule. The power to the sample is shut off after its hold at temperature. The heated mixture is held at the sintering temperature for about 5 minutes. The sample is allowed to cool. The pressure control is turned off after the temperature has fallen below 500 degrees Celsius. The samples are cooled to room temperature. The resultant product is Sample 4, which has the compositional distribution indicated in Table 3.

Samples 5-14 are prepared using a procedure similar to the one described above for the preparation of the sample 4. The composition of samples 5-14 are indicated in Table 3.

Table 3 shows that the metal oxide varistor materials may perform relatively well, displaying a breakdown field of greater than about 1700 volts per millimeter and a good nonlinearity coefficient (α) of greater than about 75, but still having a relatively low sintering temperature.

TABLE 3

| Composition | | | | Samples | Sample | Sample | Sample |
|---|---|---|---|---|---|---|---|
| (Wt percent) | Sample 4 | Sample 5 | Sample 6 | 7-11 | 12 | 13 | 14 |
| ZnO | 85.5 | 94 | 94.69 | 94.69 | 95.0 | 84.0 | 94.0 |
| Bi₂O₃ | 2 | 0.5 | 3 | 3 | 3.5 | 3 | 3 |
| Sb₂O₃ | 3 | 1.4 | 1.5 | 1.5 | 0.2 | 3 | 0.1 |
| Al₂O₃ | 3 | — | 0.01 | 0.01 | 0.1 | — | — |
| SiO₂ | 3 | 2 | — | — | 0.1 | 0.5 | 1.0 |
| Cr₂O₃ | 0.95 | 0.04 | — | — | 0.1 | — | — |
| MnO | — | — | — | — | 0.1 | 0.5 | — |
| Mn₂O₃ | — | 0.6 | — | — | 0.1 | — | — |
| MgO | 0.05 | — | — | — | 0.1 | 1 | — |
| Fe₂O₃ | — | — | — | — | 0.1 | 0.5 | — |
| Co₂O₃ | — | — | — | — | 0.1 | 2.5 | — |
| Co₃O₄ | 2.5 | 0.5 | 0.5 | 0.5 | 0.1 | — | — |
| NiO | — | 0.96 | 0.2 | 0.2 | 0.1 | 3 | — |
| SnO₂ | — | — | — | — | 0.1 | — | — |
| Li₂CO₃ | — | — | 0.1 | 0.1 | 0.1 | 1.5 | 0.9 |
| LiBiO₃ | — | — | — | — | 0.1 | — | 1 |
| CaO | — | — | — | — | 0.1 | 0.5 | — |
| Breakdown Field | >1800 | >1800 | >1850 | — | — | — | — |
| (V/mm) | | | | | | | |
| Nonlinearity | >75 | >80 | >75 | — | — | — | — |
| coefficient (α) | | | | | | | |

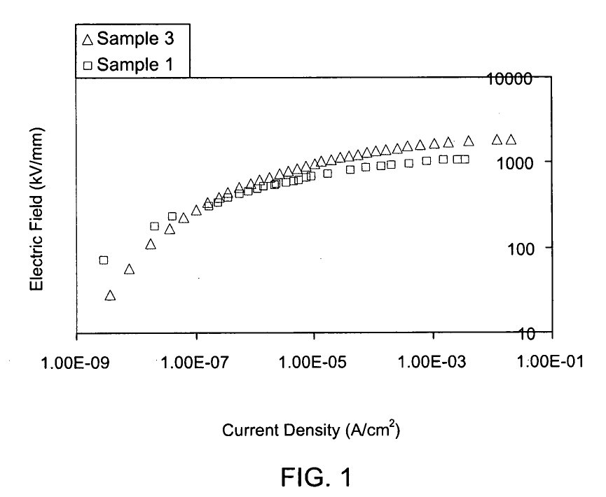

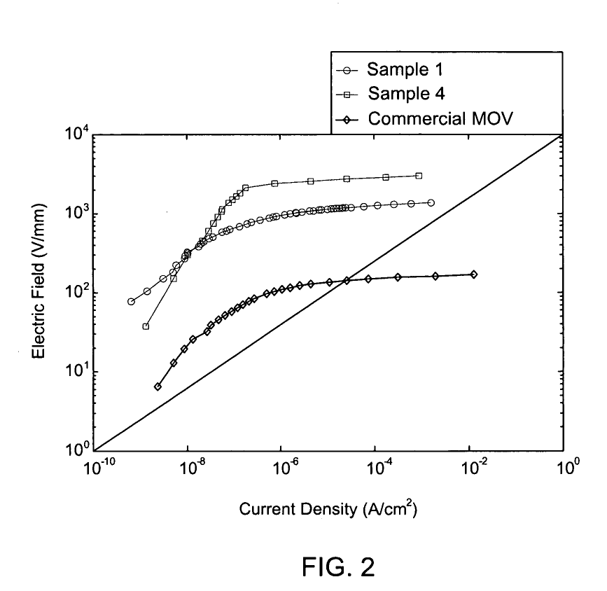

FIG. 1 and 2 show the a graph of the electric field versus the current density (current voltage graph) for a composition in accordance with one embodiment of the invention and a comparative sample. In FIG. 1 shows that the performance of the metal oxide varistor made of the sintered mass of sample 3 is better when compared to the metal oxide varistor made from the conventional sintering of comparative sample 1. In FIG. 2 shows that the performance of the metal oxide varistor made of the sintered mass of sample 4 is better when compared to the metal oxide varistor made from the conventional sintering of comparative sample 1 and commercial available metal oxide varistor.

Microstructure formation may depend at least in part on the sintering process. FIGS. 3 compares the microstructure of a commercially available metal oxide varistor material Comparative Sample 1 (FIG. 3a) with a metal oxide varistor material of Sample 4 (FIG. 3b). The average grain size of the metal oxide varistor materials of Sample 4 (sintered using spark plasma sintering) is less than 0.5 micrometer; and, this is in comparison to the commercially available metal oxide varistor material Comparative Sample 1 that has a grain size that is greater than 10 micrometers. The density of the sample 4 prepared using spark plasma sintering is found to be around 6.02 gram per cubic centimeter. Uniform structure is also indicated in the sample 4. Several phases may coexist in the metal oxide varistor materials of Samples 4. These phases may include the major conductive phase of less than 0.5 micrometer in size and one or more secondary phases located at the grain boundaries and in the grain boundary layer, which itself may include various dopants and sintering additives.

In the specification and claims, reference will be made to a number of terms have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be”.

Reactants and components referred to by chemical name or formula in the specification or claims hereof, whether referred to in the singular or plural, may be identified as they exist prior to coming into contact with another substance referred to by chemical name or chemical type (e.g., another reactant or a solvent). Preliminary and/or transitional chemical changes, transformations, or reactions, if any, that take place in the resulting mixture, solution, or reaction medium may be identified as intermediate species, master batches, and the like, and may have utility distinct from the utility of the reaction product or final material. Other subsequent changes, transformations, or reactions may result from bringing the specified reactants and/or components together under the conditions called for pursuant to this disclosure. In these, other subsequent changes, transformations, or reactions the reactants, ingredients, or the components to be brought together may identify or indicate the reaction product or final material.

The embodiments described herein are examples of articles, compositions, and methods having elements corresponding to the elements of the invention recited in the claims. This written description may enable those of ordinary skill in the art to make and use embodiments having alternative elements that likewise correspond to the elements of the invention recited in the claims. The scope of the invention thus includes articles, compositions and methods that do not differ from the literal language of the claims, and further includes other articles, compositions and methods with insubstantial differences from the literal language of the claims. While only certain features and embodiments have been illustrated and described herein, many modifications and changes may occur to one of ordinary skill in the relevant art. The appended claims cover all such modifications and changes.

1. A method, comprising:
contacting a transition metal oxide, a sintering additive, and a grain growth inhibitor additive to form a mixture, wherein the transition metal oxide comprises particles that have an average diameter less than about 1 micrometer; and
sintering the mixture at a temperature profile that is sufficiently high that a sintered mass is formed from the mixture, wherein the sintering comprises at least one of a microwave sintering or a spark plasma sintering, and wherein the thermal profile is less than about 1050 degrees Celsius.

2. The method of claim 1, wherein the sintering comprises spark plasma sintering.

3. The method of claim 2, wherein the spark plasma sintering is carried out in a temperature in a range of from about 450 degrees Celsius to about 1000 degrees Celsius.

4. The method of claim 2, wherein the spark plasma sintering is carried on for a time period in a range of from about 1 minute to about 30 minutes.

5. The method of claim 1, wherein the sintering comprises microwave sintering.

6. The method of claim 5, wherein the microwave sintering is carried out in a temperature in a range of from about 500 degrees Celsius to about 1050 degrees Celsius.

7. The method of claim 5, wherein the microwave sintering is carried out at a heating rate of at least about 600 degrees Celsius per minute.

8. The method of claim 1, further comprising calcining the transition metal oxide and the sintering additive together before forming the mixture, and the calcining comprises heating to a temperature of about 450 degrees Celsius.

9. The method of claim 1, further comprising contacting the sintered mass with an electrically conductive material, and forming an electrical connection therebetween.

10. The method as defined in claim 49, wherein the electrically conductive material has a melting point that is less than 1050 degrees Celsius, and forming the electrical connection comprises forming the electrically conductive material into an electrode.

11. The method as defined in claim 1, further comprising selecting the sintering additive to comprise one or more oxides of lithium, antimony, bismuth, cobalt, manganese, or silicon.

12. The method as defined in claim 11, further comprising selecting the sintering additive to comprise one or both of LiBiO₃, or Li₂CO₃.

13. The method as defined in claim 1, further comprising selecting the transition metal oxide to be present in an amount that is greater than about 80 percent by weight, based on the total weight of the sintered mass.

14. The method as defined in claim 1, further comprising selecting the amount of the sintering additive to be less than about 15 percent by weight, based on the total weight of the the sintered mass.

15. The method as defined in claim 1, further comprising selecting the grain growth inhibitor additive to comprise one or more of SiO₂, Sb₂O₃, CaO, Al₂O₃, MgO, or Fe₂O₃.

16. The method as defined in claim 1, further comprising selecting the grain growth inhibitor additive to be present in an amount that is less than about 10 percent by weight, based on the total weight of the the sintered mass.

17. The method as defined in claim 1, further comprising adding a a grain boundary additive to the mixture prior to sintering.

18. The method as defined in claim 17, further comprising selecting the grain boundary additive to comprise Co₃O₄, Cr₂O₃, Bi₂O₃, Pr₂O₃, NiO, or SnO₂.

19. The method as defined in claim 17, further comprising selecting the amount of the grain boundary additive to be less than about 10 percent by weight, based on the total weight of the the sintered mass.

20. The method as defined in claim 1, wherein the sintered mass comprises a plurality of cores, and the temperature profile and a an average particle size of the transition metal oxide are selected to form an average distance from one core to an adjacent core in the plurality of cores is less than about 1 micrometer after sintering.

21. The method as defined in claim 20, wherein the average diameter of the cores is less than about 1 micrometer.

22. The method as defined in claim 20, wherein the cores are separated from each other by a grain boundary layer, and a mean value for a thickness of the grain boundary layer is less than 50 nanometers.

23. The method as defined in claim 22, wherein the cores each define a grain boundary in the sintered mass, and an average distance from a grain boundary of one core to a grain boundary of an adjacent core in the sintered mass is less than about 1 micrometer.

24. The method as defined in claim 17, wherein selecting the grain boundary additive results in the average thickness of the grain boundary layer being less than about 400 nanometers.

25. The method as defined in claim 1, further comprising subjecting the sintered mass to an electrical potential, and the sintered mass exhibits a dielectric strength or breakdown field of greater than about 100 kV/mm.

26. The method as defined in claim 1, wherein the sintered mass has a non-linearity coefficient of greater than about 25.

27. The method as defined in claim 1, further comprising forming the sintered mass with a homogenous microstructure.

28. A method, comprising:
contacting a transition metal oxide, a sintering additive, and a grain growth inhibitor additive to form a mixture, wherein the transition metal oxide comprises particles that have an average diameter less than about 1 micrometer; and
sintering the mixture at less than about 1050 degrees Celsius to form a sintered mass, wherein the sintering comprises at least one of microwave sintering or spark plasma sintering, and while sintering forming an electrode from an electrically conductive material.

29. A method, comprising:
contacting a transition metal oxide with a sintering additive to form a premix, wherein the transition metal oxide comprises particles that have an average diameter less than about 1 micrometer;
calcining the premix, wherein the calcining comprises heating to a temperature of at least about 450 degrees Celsius to provide a calcined mass;
contacting the calcined mass with a grain growth inhibitor additive to form a mixture; and
sintering the mixture at a temperature profile that is sufficiently high that a sintered mass is formed from the mixture, and the thermal profile is less than about 1050 degrees Celsius;
and wherein the sintering comprises at least one of microwave sintering or spark plasma sintering.
